(19) United States
(12) Patent Application Publication
(10) Pub. No.: US 2013/0167741 A1
(43) Pub. Date: Jul. 4, 2013

(54) Method for decorative patterning on the handbag

(71) Applicant: Bok Jin Sa, Namyangju-City (KR)

(72) Inventor: Bok Jin Sa, Namyangju-City (KR)

(21) Appl. No.: 13/385,250

(22) Filed: Feb. 10, 2012

(30) Foreign Application Priority Data
Jan. 2, 2012 (KR) 10-2012-0000209

(51) Int. Cl. B41M 1/10

(52) U.S. Cl. 101/170

(57) ABSTRACT

A method for decorative patterning on the handbag sheet has developed, the method comprising that; applying a paint (200) on an outer circumference of a forming roller (100) with a printing shape (120) formed a plurality of semi-spherical intaglios thereon for introducing the paint into the semi-spherical intaglios (110); passing a handbag sheet (10) made of a fabric or leather between a pressing roller (20) and the forming roller (100); and drying and hardening the paint on the handbag sheet to form a stereoscopic surface pattern (11) combined with protruded embossing on the surface of the handbag sheet. The present method can print the Patterns on the fabric sequentially without cutting by adopting a printing roller with semi-spherical intaglio patterns. Thus, the present method can improve the product and simplify the work process for reducing the hardening time of the printed paint.

This application claims priority from Korean Patent Application No. 10-2012-0000209 filed on Jan. 2, 2012 in the Korean Intellectual Property Office, the entire disclosure of which is incorporated herein by reference.

### BACKGROUND OF THE INVENTION

1. Field of the Invention

The present invention relates to a method for forming patterns on the handbag surface. More specifically, the method is used a roller, which has equipped a semi-spherical intaglio patterns for forming patterns on the handbag surface, and the coating liquid material, which is containing the urethane resin or epoxy resin as a main raw material for preventing to fade the color of the patterns formed on the handbag surface. The method of roller coating is adopted to get rid of the manual works for obtaining the best quality of the patterns.

2. Related Prior Art

In general, the handbags made of a fabric or leather can be more merchantable, if they have decorated with attractive and popular patterns, which have improved the quality as well as the popularity by decorating a variety of patterns (such as the logo of the commodity).

On the other hand, the handbag sheet, which is used as a main material, has a variety of pre-printed patterns on the raw material of the handbag.

As a representative one of the general methods for forming patterns on the surface of the handbag sheet, there is a method in which a silk screen printing method is adopted. In the silk screen printing method, a screen-shaped die is completed by making a photosensitive liquid stay on the fabric excluding the portion to be printed after installing the fabric on a die tautly.

Next, after placing a sheet to be printed under the die, ink (paint) is uniformly applied on the fabric through a push rod made of rubber. Printing and heat curing or cold setting are carried out on the surface of the printed sheet obtained through such a process.

However, the above-mentioned conventional silk screen is carried out by manual work, and each handbag sheet should be printed after cutting the handbag sheet beforehand. Therefore, the process is very cumbersome and has a problem that it takes a considerably long time for ink to harden.

Another problem is that because the surface pattern can be printed only in a planar shape the value of handbag, which emphasizes elegance, is rather lowered. Yet another problem is that the pattern is degenerated or erased easily if it is used for a long time.

### SUMMARY OF THE INVENTION

Therefore, it is an object of the present invention to provide a method for forming patterns on the surface of a handbag sheet, whereby it is possible to pressure-form a paint containing a resin of high viscosity as a main raw material on the surface of the handbag sheet by using a roller with semi-spherical intaglio patterns molded on the surface and to print continuously on the fabric of the handbag sheet itself by adopting an automatic printing method by the roller, so that a work process can be simplified, and the hardening rate of the paint formed on the surface of the handbag sheet is so fast that manufacturing productivity can be remarkably improved.

Another object of the present invention is to provide a method for forming surface patterns of the handbag sheet whereby the beauty and elegance of a handbag can be further enhanced as the surface patterns have convex patterns of an embossed shape and they are not easily discolored or erased even if it is used for a long time by providing a strong adhesiveness thanks to paint with high viscosity.

To accomplish the above objects, there is provided a method for forming patterns on a surface of a handbag sheet, comprising: applying a paint on an outer circumference of a forming roller with a printed shape defined by a plurality of semi-spherical intaglios formed thereon, to introduce the paint into the semi-spherical intaglios; passing a handbag sheet made of a fabric or leather between a pressing roller and the forming roller; and drying and hardening the paint on the handbag sheet, to form a stereoscopic surface pattern combined with protruded embossing on the surface of the handbag sheet.

The method for forming patterns on the surface of the handbag sheet of the present invention can form patterns in a row on the whole surface of the fabric itself that is not cut by using a roller having semi-spherical intaglio patterns, and can further improve manufacturing productivity thanks to the resulting simplification of work process and the shortening of the hardening rate of paint.

Moreover, the patterns formed on the surface of the handbag sheet can be stereoscopic patterns of various shapes by dint of combination of embossed patterns, so that the beauty and elegance of the handbag can be further enhanced, and the discoloration or peeling of patterns can be prevented even if the handbag is used for a long time.

### BRIEF DESCRIPTION OF THE DRAWINGS

FIG. 1 is a sectional view showing a roller applied to a method for forming a pattern on the surface of the handbag sheet according to the present invention.

FIG. 2 is a sectional view showing how a pattern is printed on the surface of the handbag sheet according to the method of the present invention.

FIG. 3 is a sectional view showing how a pattern was printed on the surface of the handbag sheet according to the method of the present invention.

FIG. 4 is a plan view showing a printed face formed on the surface of the handbag sheet according to the method of the present invention.

### DETAILED DESCRIPTION OF THE PREFERRED EMBODIMENTS

Hereinafter, preferable embodiments of the present invention will be described with reference to the accompanying drawings.

Prior to this, terms or words used in the specification and claims should not be construed as limited to a lexical meaning, and should be understood as appropriate notions by the inventor based on that he/she is able to define terms to describe his/her invention in the best way to be seen by others.

Therefore, embodiments and drawings described herein are simply exemplary and not exhaustive, and it will be understood that various modifications and equivalents may be made to take the place of the embodiments.

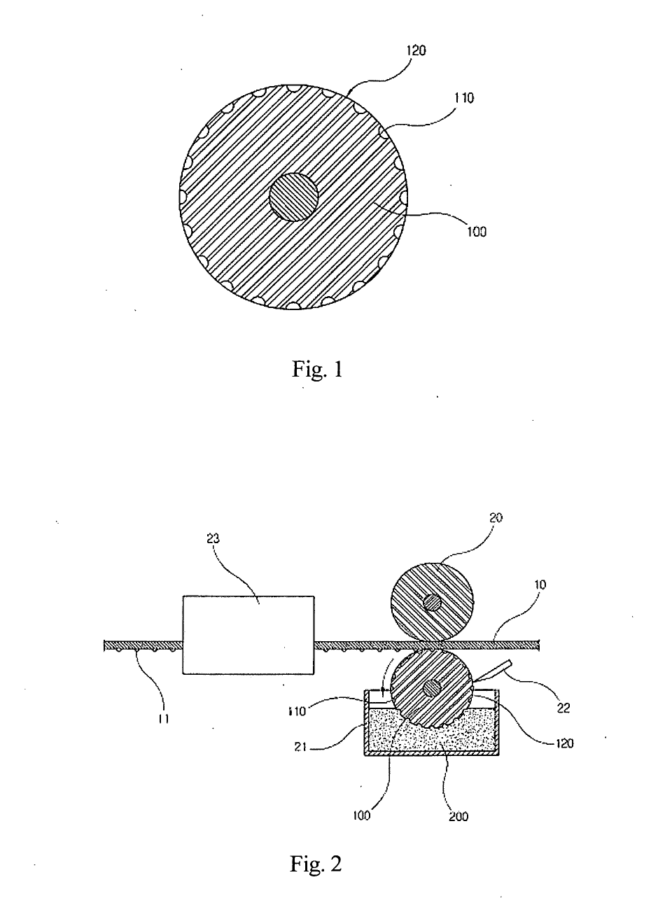

FIG. 1 is a sectional view showing a roller applied to a method for forming a pattern on the surface of the handbag sheet according to the present invention, and FIG. 2 is a sectional view showing how a pattern is printed on the surface of the handbag sheet according to the method of the present invention.

As shown in FIG. 1, a method for forming patterns on the surface of the handbag sheet according to the present invention uses a forming roller 100 with a plurality of intaglios 110 formed on the outer circumference thereof. The intaglio 110 of the forming roller 100 is made in a semi-spherical shape, and the printed shape 120 to be formed on the handbag sheet 10 is determined by the array of the intaglios 110.

In order to form a pattern on the surface of the handbag sheet 10 by using the forming roller 110, a method whereby a paint 200 stored in a paint reservoir 21 is supplied to the surface of the forming roller 100 according to the rotation of the forming roller 100 is used, as shown in FIG. 2. At this time, the printed shape 120 may have various shapes such as a trademark, design or logo according to the kind of the handbag.

Next, the paint 200 supplied to the surface of the forming roller 100 blades the paint applied to the surface of the forming roller 100 by using a blade 22. In this process, the paint 200 that penetrated into the intaglios 100 stays therein, and the paint smeared on the surface of the forming roller 100 other than the intaglios is removed.

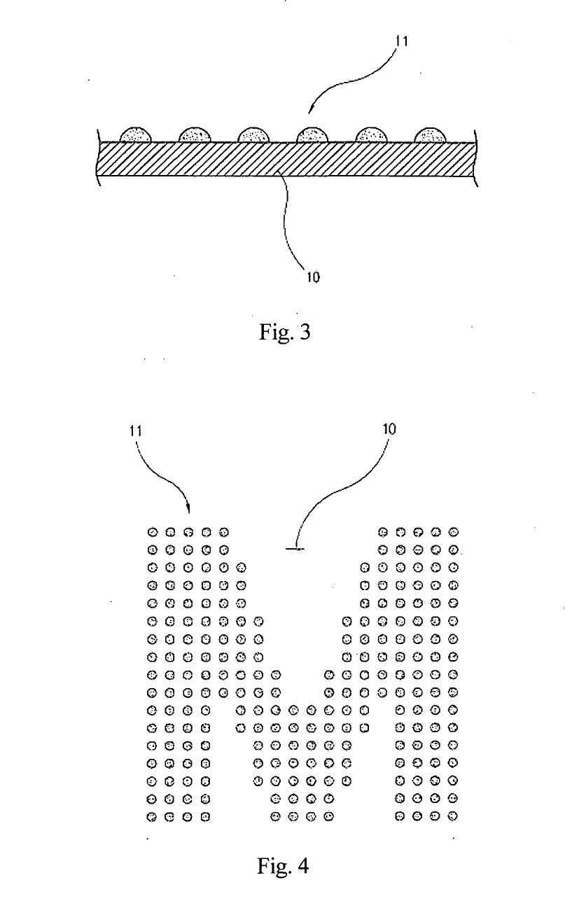

Then, the handbag sheet 10 passes between the forming roller 100 and the pressing roller 20, and the paint 200 that penetrated into the intaglios 200 of the forming roller 100 with the pressing made with the pressing roller 20 is pressed and adsorbed on the surface of the handbag sheet 10. Accordingly, as shown in FIG. 3, on the surface of the handbag sheet 10 is formed a surface pattern 11 of a stereoscopic shape combined with relief dome-shaped embossing.

After this, if the handbag sheet 10 with the surface pattern 11 formed is dried, the forming of the desired surface pattern 11 is completed on the surface of the handbag sheet 10, as shown in FIG. 4.

As mentioned above, the surface pattern 11 can be made in various shapes according to the printed shape 120 of the forming roller 110. Namely, various stereoscopic surface patterns 11 of trademark or logo can be obtained according to the type of handbags.

Meanwhile, the paint 200 that is applied to the surface of the forming roller 100 in order to form the surface pattern 11 can be used by mixing such as a resin, cross-linking agent, UV stabilizer, hardening accelerator, disperse dye, bubble inhibitor, and bright powder.

At this time, as for the resin, it is preferable to use any one of a urethane resin or an epoxy resin. The resin, which is the main raw material of the paint, can provide an excellent adsorptive power due to its high viscosity, by adding 70 to 80 wt % (percent by weight), relative to a total 100 wt % of the paint compound.

The cross-linking agent includes such as a polyisocyanate, and it is preferable to add 5 to 10 wt %, relative to a total 100 wt % of the paint compound.

Here, the cross-linking agent is a component playing a bridging role between polymer chains and imparts mechanical strength and chemical stability such as hardness and elasticity to the resin. At this time, if the content of the polyisocyanate is less than 5 wt %, the mixing with each component does not occur and the elasticity is lowered, so it is difficult to obtain the desired shape combination of the surface pattern 11. On the other hand, it the content exceeds 10 wt %, there will be a problem of the texture becoming inferior due to excessive elasticity.

As for the UV stabilizer, it is preferable to use any one of UV stabilizers of a phosphate compound or a phosphorus compound. Preferably, the UV stabilizer is included in an amount of 0.1 to 0.2 wt %, relative to a total 100 wt % of the paint compound.

Here, the UV stabilizer is to improve stability in mixing the components. The phosphate component plays a role of mitigating impact added to the surface pattern of a hardened embossed shape as well as preventing the corrosion of the paint. At this time, if the content of the phosphate is less than 0.1 wt %, degeneration happens due to the corrosion, while if it exceeds 0.2 wt %, there will be a problem of the surface pattern 11 becoming stiff.

Preferably, the hardening accelerator is included in an amount of 0.3 to 0.5 wt %, relative to a total 100 wt % of the paint compound. As hardening accelerator used in the present invention, there is a conventionally used calcium chloride or magnesium chloride. Adding hardening accelerator to the paint 200 of the present invention can shorten the hardening rate of the paint. At this time, if the content of the hardening accelerator is less than 0.3 wt %, the hardening rate is lowered, while if it exceeds 0.5 wt %, there will be a problem that the surface pattern is broken due to excessively fast hardening or the paint is not properly adsorbed on the surface of the handbag sheet 10.

Preferably, the disperse dye is included in an amount of 1 to 5 wt %, relative to a total 100 wt % of the paint compound. If the disperse dye is mixed with the paint 200, it melts to permeate into the inside as well as the surface of the fiber and plays a coloring role, so it provides stable color to the hardened surface pattern 11.

At this time, if the content of the disperse dye is less than b 1 wt %, the coloring power decreases, so non-uniform colors are obtained, while if it exceeds 5 wt %, there is a problem of getting unclear colors due to excessive coloring.

As for the bubble inhibitor, a silicone compound is preferable, and is included in an amount of 0.1 to 0.2 wt %, relative to a total 100 wt % of the paint compound. The silicone has a high density, so it is possible to prevent generation of bubbles by mixing it with paint 200. At this time, if the content of the silicone compound is less than 0.1 wt %, the bubble inhibition effect decreases, while if it exceeds 0.2 wt %, there is a problem of non-uniformity of surface pattern.

As for the bright powder, an either silver paste with a nanoparticle shape or an alumina powder is preferable, and is included in an amount of 10 to 20 wt %, relative to a total 100 wt % of the paint compound. The bright powder plays a role of providing pearl-caused brightness to the surface pattern 11 formed on the handbag sheet 10, and makes it possible to identify the surface pattern 11 formed on the handbag sheet 10 easily at any angle. At this time, if the content of the silver paste is less than 10 wt %, brightness decreases, while if it exceeds 20 wt %, there is a problem of causing difficulty in identifying the surface pattern 11 due to a too high brightness.

At this time, in using the paint 200 as described above, the handbag sheet 10 with the surface pattern 11 formed thereon is dried by passing it for 1 to 2 minutes through a drying furnace with a temperature maintained at 70 to 150° C.

As for the paint 200 applied on the surface of the forming roller 100 to form the surface pattern 11, in which the resin is used as the main raw material, 80 to 85% of UV hardening resin may be used. At this time, a commonly used UV hardening resin which may be used may be any one of a urethane acrylate, a polyester acrylate, and an epoxy acrylate.

And to the paint may be mixed the hardening accelerator of 0.3 to 0.5 wt %, disperse dyes of 1 to 5 wt %, a silicone bubble inhibitor of 0.1 to 0.2 wt %, and a bright powder of 10 to 20 wt % of any one of a silver paste with a nanoparticle shape or an alumina powder.

At this time, with the pressing made with the handbag sheet 10 by the pressing roller 20, the paint 200 that got into the intaglios 110 of the forming roller 100 is pressed and adsorbed on the surface of the handbag sheet 10. In this state, the handbag sheet 10 is dried when it passes through the drying furnace 23 by using the UV hardening method using a UV lamp.

As mentioned above, the method for forming patterns on the surface of the handbag sheet using paint according to the present invention excels in workability as continuous work is possible because patterns are formed on a handbag sheet by using the forming roller, and makes it possible to obtain a handbag sheet of excellent quality with less deformation and high image durability as paint with high viscosity is used and having an excellent brightness quality on the surface thereof.

While the present invention has been described with reference to the preferred embodiments, it will be understood by those skilled in the related art that various modifications and variations may be made therein without departing from the scope of the present invention as defined by the appended claims.

What is claimed is:

1. A method for decorative patterning on a handbag sheet, the method comprising the steps of:
applying paint (200) on an outer circumference of a forming roller (100) with a printing shape (120) formed a plurality of semi-spherical intaglios thereon to introduce the paint into the semi-spherical intaglios (110);
passing a handbag sheet (10) made of a fabric or leather between a pressing roller (20) and the forming roller (100); and
drying and hardening the paint on the handbag sheet to form a stereoscopic surface pattern (11) combined with protruded embossing on the surface of the handbag sheet.

2. The method for decorative patterning according to claim 1, wherein the paint (200) compound comprises:
70 to 80 wt % of a resin of either one of a urethane resin or an epoxy resin,
5 to 10 wt % of a cross-linking agent of a polyisocyanate,
0.1 to 0.2 wt % of a UV stabilizer of either one of a phosphate compound or a phosphorus compound,
0.3 to 0.5 wt % of a hardening accelerator,
1 to 5 wt % of a disperse dye,
0.1 to 0.2 wt % of a silicone bubble inhibitor, and
10 to 20 wt % of a bright powder of any one of a silver paste with a nanoparticle shape or an alumina powder.

3. The method for decorative patterning according to claim 1, wherein the handbag sheet is printed with the paint by passing through a drying furnace (23) for hardening and the surface pattern (11) is dried.

4. The method for decorative patterning according to claim 3, wherein the handbag sheet with the printed pattern (11) is drying for one to two minutes at a temperature of 70° C. to 150° C. for hardening the printed paint.

5. The method for decorative patterning according to claim 1, wherein the paint (200) compound comprises:
80 to 85 wt % of a UV hardening resin of either one of a urethane acrylate, a polyester acrylate and an epoxy acrylate,
0.3 to 0.5 wt % of a hardening accelerator,
1 to 5 wt % of a disperse dye,
0.1 to 0.2 wt % of a silicone bubble inhibitor, and
10 to 20 wt % of a bright powder of any one of a silver paste with a nanoparticle shape or an alumina powder.

6. The method for decorative patterning according to claim 1, wherein the handbag sheet printing with the paint is passed through a drying furnace (23), which is provided an UV lamp for UV hardening when the surface pattern (11) is dried.
